(19) United States
(12) Patent Application Publication
(10) Pub. No.: US 2020/0320567 A1
(43) Pub. Date: Oct. 8, 2020

(54) System and Method to Generate Rewards to Users Based on Content Consumption

(71) Applicant: Vipul Chaube, Maharashtra (IN)

(72) Inventor: Vipul Chaube, Maharashtra (IN)

(21) Appl. No.: 16/429,626

(22) Filed: Jun. 3, 2019

(30) Foreign Application Priority Data
Apr. 4, 2019 (IN) 201921013633

(51) Int. Cl. G06Q 30/02

(52) U.S. Cl. CPC G06Q 30/0239; G06Q 30/0218; G06Q 30/0236

(57) ABSTRACT

A system and method to generate rewards to a plurality of users based on content consumption. The system includes a user registration module configured to register the plurality of users. The system also includes a content consumption data retrieval module is configured to retrieve consumption data of one or more multimedia contents. Each of the one or more multimedia contents includes a loyalty value. The system also includes a user score generation module is configured to generate a user score based on at least one of the one or more multimedia contents viewed by the plurality of users and the corresponding loyalty value of the one or more multimedia contents. The system also includes a reward generating module is configured to generate a plurality of rewards based on a generated user score.

### CROSS-REFERENCE TO RELATED APPLICATION

This application claims the benefit of complete patent application having Patent Application No. 201921013633 filed on Apr. 4, 2019 in India.

### FIELD OF INVENTION

Embodiments of a present disclosure relate to a loyalty program for television and Over the Top (OTT) media service customers, and more particularly to a system and method to generate rewards to users based on content consumption.

### BACKGROUND

Loyalty program is a type of a marketing strategy. The loyalty program is designed to encourage and attract one or more customers to buy products and services by a retailer upon providing rewards. The Loyalty program helps retailers to make their customers permanent and use the services of businesses regularly. Loyalty programs are being used in different sectors such as home entertainment industry, business sectors, e-commerce and the like.

One such sector being home entertainment industry is having a considerable growth in the recent decades, so that there is a need in the home entertainment industry to attract the customers (E.g., viewers/listeners). In a conventional approach, Multiple System Operators (MSO) will telecast programs as per their plan but a user may not like the program which the MSO operator telecasts. So, there is a need for a personalized content telecast. Due to such limitation on telecasts by the MSO, the user does not have a choice to customise the telecast, henceforth the user's money will get wasted thereby making such an approach less economical and less interesting as the user cannot get a personalized content.

In comparison with the conventional approach, a newer approach describes a broadcasting program through over-the-top (OTT) media service which refers to delivering a plurality of contents (E.g., audio, video, online games and other media content) over the Internet without the interference of a multiple-system operator (MSO). In OTT, a user may get personalized content over the internet. But at the same time, user's priceless time is spent on watching movies, listening to songs and the like without any monetary returns. The OTT may provide the personalized content, but the user needs to invest the money for smart computing devices and the internet facility. The money invested in smart computing devices and the internet facility which will make the users invest without having an option to earn money/rewards/credit points. Such limitation leads to a lack of interest in the user to invest more time on such entertaining programs.

Hence, there is a need for an improved system and method to generate rewards to users based on content consumption to address the aforementioned issues.

### BRIEF DESCRIPTION

In accordance with one embodiment of the disclosure, a system to generate rewards to users based on content consumption is provided. The system includes a user registration module configured to register the plurality of users upon receiving a plurality of user details. The system also includes a content consumption data retrieval module operatively coupled to the user registration module. The content consumption data retrieval module is configured to retrieve consumption data of one or more multimedia contents viewed by the plurality of users via a user device. Each of the one or more multimedia contents includes a loyalty value. The system also includes a user score generation module coupled to the content consumption data retrieval module. The user score generation module is configured to generate a user score based on at least one of the one or more multimedia contents viewed by the plurality of users and the corresponding loyalty value of the one or more multimedia contents. The loyalty value is based on the consumption data of the one or more multimedia contents. The system also includes a reward generating module operatively coupled to the user score generation module. The reward generating module is configured to generate a plurality of rewards based on a generated user score.

In accordance with another embodiment of the disclosure, a method for generating rewards to users based on content consumption is provided. The method includes registering the plurality of users upon receiving a plurality of user details by a user registration module. The method also includes retrieving consumption data of one or more multimedia contents viewed by the plurality of users via a user device by a content consumption data retrieval module. The method also includes generating a user score based on at least one of the one or more multimedia contents viewed by the plurality of users and the corresponding loyalty value of the one or more multimedia contents by a user score generation module. The method also includes generating a plurality of rewards based on a generated user score by a reward generating module.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system to generate rewards to a plurality of users based on content consumption in accordance with an embodiment of the present disclosure;

FIG. 2 is a block diagram representation of one embodiment of the system to generate rewards to the plurality of users based on the content consumption of FIG. 1 in accordance with an embodiment of the present disclosure;

FIG. 3 block diagram of a computer or a server in accordance with an embodiment of the present disclosure; and

FIG. 4 is a flow diagram representing steps involved in a method for generating rewards to a plurality of users based on content consumption in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprise”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to Which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system to generate rewards to a plurality of users based on content consumption. The system includes a user registration module configured to register the plurality of users upon receiving a plurality of user details. The system also includes a content consumption data retrieval module operatively coupled to the user registration module. The content consumption data retrieval module is configured to retrieve consumption data of one or more multimedia contents viewed by the plurality of users via a user device. Each of the one or more multimedia contents includes a loyalty value. The system also includes a user score generation module coupled to the content consumption data retrieval module. The user score generation module is configured to generate a user score based on at least one of the one or more multimedia contents viewed by the plurality of users and the corresponding loyalty value of the one or more multimedia contents. The loyalty value is based on the consumption data of the one or more multimedia contents. The system also includes a reward generating module operatively coupled to the user score generation module. The reward generating module is configured to generate a plurality of rewards based on a generated user score.

FIG, 1 is a block diagram representation of a system 10 to generate rewards to a plurality of users based on content consumption in accordance with an embodiment of the present disclosure. The system 10 includes a user registration module 20 configured to register the plurality of users upon receiving a plurality of user details. In one embodiment, the plurality of user details may include, a name of the plurality of users, an age of the plurality of users, an address of the plurality of users, an Electronic Mail (E-Mail) of the plurality of users, a phone number of the plurality of users, a nationality of the plurality of users, and the like. In one embodiment, the plurality of users may be a person who is a customer of over the top (OTT) media service.

The system 10 also includes a content consumption data retrieval module (30) operatively coupled to the user registration module 20. The content consumption data retrieval module 20 is configured to retrieve consumption data of one or more multimedia contents viewed by the plurality of users via a user device. Each of the one or more multimedia contents includes a loyalty value. In one embodiment, the content consumption data of the one or more multimedia contents comprises at least one of a type of the one or more multimedia contents, a time at which the one or more multimedia contents is viewed, cumulative watch-time of the one or more multimedia contents by the user device. In one embodiment, the user device may be a computing device such as a hand-held device or a portable device. In such embodiment, the computing device may include, but not limited to, a laptop, a desktop, a notebook, a tablet, a smartphone and the like.

In one embodiment, the loyalty value may be a value associated with the one or more multimedia content. In such embodiment, the loyalty value may vary based on content consumption data of the one or more multimedia contents. In one embodiment, the one or more multimedia contents may include, but not limited to, a free content which is seen at the appointed time frame, a free content which is seen after the time frame, a premium content, a pay per view content, a plurality of contents with different price, a plurality of contents with different importance and the like. As used herein, the term ‘free content’ is defined as a content which will be available for free of cost.

The system 10 also includes a user score generation module 40 operatively coupled to the content consumption data retrieval module 30. The user score generation module 40 is configured to generate a user score based on at least one of the one or more multimedia contents viewed by the plurality of users and the corresponding loyalty value of the one or more multimedia contents. In one embodiment, the score may correspond to a numeric score generated to the corresponding plurality of users based on at least one of the one or more multimedia contents viewed by the plurality of users and the corresponding loyalty value of the one or more multimedia contents.

The system 10 also includes a reward generating module 50 operatively coupled to the user score generation module 40. The reward generating module 50 is configured to generate a plurality of rewards based on a generated user score. In one embodiment, the user can apply the plurality of rewards against the one or more multimedia contents. In one embodiment, the plurality of rewards may include, but not limited to, at least one of one or more deals, discounts, coupons, freebies, and subscriptions. In one exemplary embodiment, the plurality of rewards may be generated by an authorised person who may be managing telecast of the corresponding one or more multimedia contents.

In one embodiment, the system 10 further includes a profile creation module operatively coupled to the user registration module 20, and configured to create a user profile with the plurality of user details. In one embodiment, the plurality of users may access a platform with social media login credentials. In one embodiment, the profile of the plurality of the users may include the plurality of user details.

In one embodiment, the system 10 further includes permission providing module operatively coupled to the profile creation module, and configured to generate a permission to the authorised person to access the platform upon being accessed by the corresponding plurality of users. In one embodiment, the plurality of permissions may include, but not limited to, permission to access location, permission to access user language, permission to track watch history, permission to send one or more notifications, permission to sync with calendar, and the like.

In one embodiment, the system 10 further includes a user favourites determining module operatively coupled to the user registration module 20. The user favourites determining module is configured to determine a plurality of favourite items of the plurality of the users using a psychographic analysis technique based on the one or more contents accessed or watched by the plurality of user. In one embodiment, the plurality of favourite items may include at least one of a favourite TV (Television) show, a favourite actor, a favourite actress, a favourite movie, and a favourite celebrity. In one embodiment, the may determine the plurality of favourite items of the plurality of the user from history stored in a cache memory when the user is not logged in. In another embodiment, the plurality of favourite items of the plurality of the user may be determined from the user profile when the plurality of the users is logged in. In yet another embodiment, the plurality of favourite items of the plurality of the user may be determined via a plurality of questions/answers task which may be generated to the corresponding plurality of users and may have to be answered by the corresponding plurality of users. In one embodiment, the plurality of users may provide one or more answers to each of the plurality of questions. As used herein, the term ‘psychographic analysis technique’ is defined as a qualitative methodology used to describe consumers on psychological attributes. The psychographic analysis technique has been applied to the study of personality, values, opinions, attitudes, interests, and lifestyles.

In one embodiment, the system 10 further includes a score providing module operatively coupled to the user favourites determining module, and configured to provide score to each of the plurality of users based on the plurality of favourites. In one embodiment, the score may be based on a number of one or more matched answers provided by the plurality of users.

In one embodiment, the system 10 further includes a score matching module operatively coupled to the score providing module, and configured to match the score of each of the plurality of users with one another to generate a list of a plurality of matched users.

In one embodiment, the system 10 further includes a chat list creation module operatively coupled to the rank matching module, and configured to create a chat list based on a provided rank. The chat list allows the plurality of matched users to interact via chat/talk with each other on the platform. In one embodiment, the chat list will be the same until the plurality of users do not change the plurality of favourites.

In one embodiment, the system 10 further includes a feed providing module operatively coupled to the user favourites determining module, and configured to provide a plurality of feeds. In one embodiment, the plurality of feeds may include, but not limited to, a plurality of videos, a plurality of gossips, a plurality of Tid-bits, a plurality of Trivia, a plurality of Quiz and the like.

In one embodiment, the system 10 further includes a directory module operatively coupled to the user favourites determining module, and configured to display and store a list of movies, a list of new movies, a list of most liked movies, a list of most liked shows, a list of most liked movies with the corresponding celebrities, a list of most liked celebrities, a list of trending shows, a list of trending movies and the like within a directory on the platform.

In one embodiment, the system 10 further includes a home page module operatively coupled to the user favourites determining module, and configured to display at least one of one or more screensavers, one or more wallpapers, one or more tunes, the one or more costumes, and the one or more properties seen in the content corresponding to at least each one or more movies, one or more shows, and one or more celebrities on a display of the user device. In one embodiment, the at least one of the one or more screensavers, the one or more wallpapers, the one or more tunes, the one or more costumes, and the one or more properties seen in the content may be downloaded by the plurality of users.

In one embodiment, the system 10 further includes a retail business activity module operatively coupled to the user favourites determining module, and configured to enable the plurality of users to perform at least a plurality of retail business activities and a plurality of retail purchases on at least one of the one or more screensavers, the one or more wallpapers, the one or more tunes, the one or more costumes, and the one or more properties seen in the content upon viewing the same on the display of the user device. In one embodiment, the viewing options may include one of a two-dimensional view and a three-dimensional view. In such embodiment, the at least one of the plurality of retail business activities and the plurality of purchases against the loyalty points earned as part of loyalty program.

The retail business activity module is configured to enable the plurality of users to perform the at least one of the plurality of retail business activities and the plurality of retail purchases of a plurality of properties of the at least one of the one or more movies, the one or more shows, and the one or more celebrities from the set. In one embodiment, the plurality of users may purchase a plurality of properties of the at least one of the one or more movies, the one or more shows, and the one or more celebrities from the set. In one embodiment, the plurality of properties may include, but not limited to one or more products which may be associated with the corresponding one or more multimedia content. In such embodiment, the at least one of the plurality of retail business activities and the plurality of purchases against the loyalty points earned as part of loyalty program.

In one embodiment, the system 10 further includes a celebrity score generation module operatively coupled to the content consumption data retrieval module 30. The celebrity score generation module is configured to generate a celebrity score based on a set of parameters of the one or more multimedia contents. In one embodiment, the set of parameters includes at least one of number of downloads of the one or more multimedia contents, number of completed episodes of the one or more multimedia contents, and number of repeated views of the episodes of the one or more multimedia contents. The celebrity score will be generated based on the set of parameters for the at least one of the one or more movies, the one or more shows, and the one or more celebrities which will decide popularity rating of the at least one of the one or more movies, the one or more shows, and the one or more celebrities.

In one embodiment, the system 10 further includes a playlist preparation module operatively coupled to the user favourites determining module, and configured to allow the plurality of users to make a playlist, and manage the playlist of the at least one of movies/shows/celebrity.

In one embodiment, the system 10 further includes a favourite module operatively coupled to the user favourites determining module, and configured to allow the plurality of users to add the at least one of movies/shows as favourites.

In one embodiment, the system 10 further includes a download module operatively coupled to the user favourites determining module, and configured to allow the plurality of users to download the at least one of the one or more movies, the one or more shows, and one or more songs by paying monthly and annual subscription.

In one embodiment, the system 10 further includes a score share module operatively coupled to the user favourites determining module, and configured to allow the plurality of users to share the user score/the celebrity score with friends on a social media platform.

In one embodiment, the system 10 further includes a watch feed creating module operatively coupled to the user favourites determining module, and configured to allow the plurality of users to create a watch feed with next episodes/movies.

In one embodiment, the system 10 further includes a broadcast sharing module operatively coupled to the user favourites determining module, and configured to allow the plurality of users to share the broadcast with one or more friends associated with the plurality of the users. The broadcast sharing module is configured to allow each of the plurality of users to follow the one another to listen to the broadcast done by the each of the plurality of users.

In one embodiment, the system 10 further includes a settings module operatively coupled to the profile creation module, and configured to allow the plurality of users to select at least one of a language, a theme, and one or more font styles. In one embodiment, the language selected from the list of regional languages. The settings module also configured to provide the platform details to the plurality of users. In one embodiment, the platform details may include, but not limited to, version of the platform, and a logo of the platform. The settings module also configured to allow the plurality of user to provide a rating to the platform. In one embodiment, a provided rating is to be published on a store page of the platform.

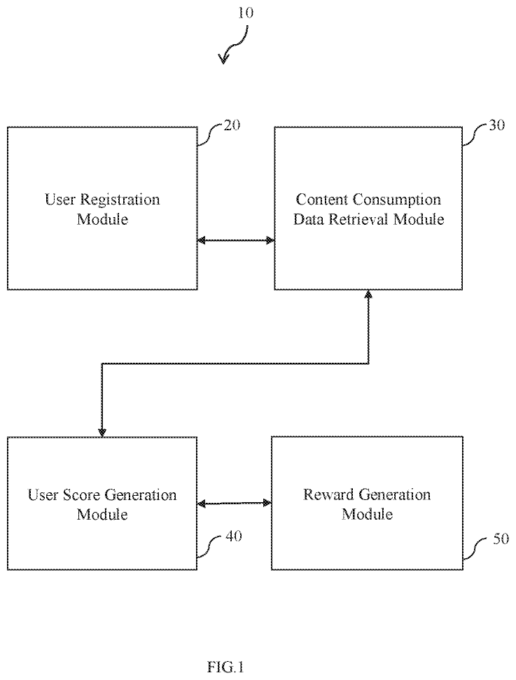

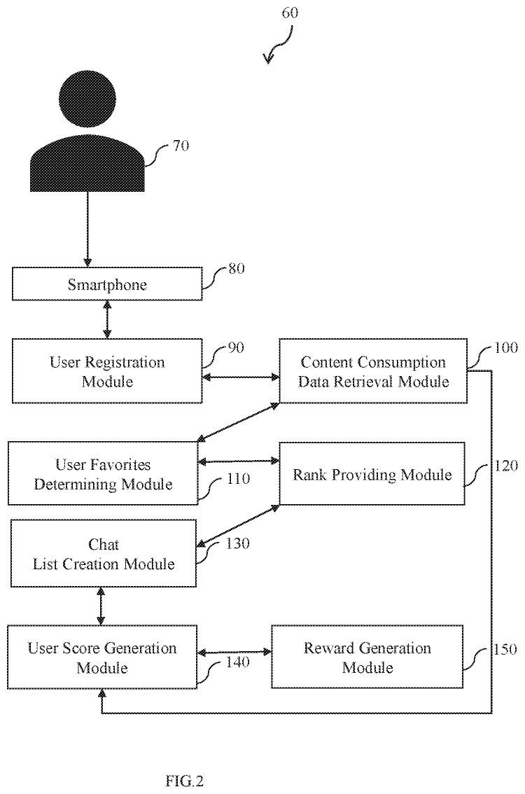

FIG. 2 is a block diagram representation of one embodiment of the system (60) to generate rewards to the plurality of users based on the content consumption of FIG. 1 in accordance with an embodiment of the present disclosure.

The system 60 to generate rewards to the plurality of users based on the content consumption is provided. A user ‘X’ 70 is registered in a platform upon providing at least one of a name of the plurality of users, an age of the plurality of users, an address of the plurality of users, an Electronic Mail (E-Mail) of the plurality of users, a phone number of the plurality of users, and a nationality of the plurality of users with help of a smartphone 80 by using a registration module 90.

The system 60 retrieves consumption data of one or more multimedia contents viewed by the plurality of users via a smartphone 80 by using a content consumption data retrieval module 100, The one or more multimedia contents includes a web series ‘A’, a web series ‘B’, and a movie ‘C’, and an online game ‘D’. Each of the one or more multimedia contents includes a loyalty (numeric value) value.

The system 60 determines a plurality of favourite items of the user ‘X’ 70 using a psychographic analysis technique based on the web series ‘A’, the web series ‘B’, and the movie ‘C’, and the online game ‘D’ accessed or watched by the user ‘X’ 70 by using a user favourites determining module 110. The system 60 determines the plurality of favourite items of the user ‘X’ 70 via a plurality of questions/answers task which may be generated to the corresponding user ‘X’ 70 and may have to be answered by the corresponding user ‘X’ 70 by using a user favourites determining module 110. The system 60 further provides a rank to the each of the user ‘X’ 70 by using a score providing module 120. The system 60 matches the rank of each of the user ‘X’ 60 with one or more users registered with the platform upon providing user details to generate a list of matched users. The system 60 creates a chat list based on a provided rank by using a chat list creation module 130. The chat list allows the matched users to interact via, chat/talk with each other on a platform.

The system 60 generates a user score based on the web series ‘A’, the web series ‘B’, the movie ‘C’, and the online game ‘D’ viewed by the user ‘X’ 70 and the corresponding a loyalty value of the web series ‘A’, a loyalty value of the web series ‘B’, a loyalty value of the movie ‘C’, a loyalty value of the online game ‘D’ by using a user score generation module 140. The system 60 generates a subscription offer against the web series ‘A’, and the web series ‘B’, the movie ‘C’, and the online game ‘D’ based on a generated user score, which will allow the user ‘X’ 70 to watch a new movie ‘E’ for free of cost by using a reward generation module.

The user registration module 90, the content consumption data retrieval module 100, the user score generation module 140, and the reward generation module 150 in the FIG. 2 are substantially similar to a user registration module 20, a content consumption data retrieval module 30, a user score generation module 40, and a reward generation module 50 of FIG. 1.

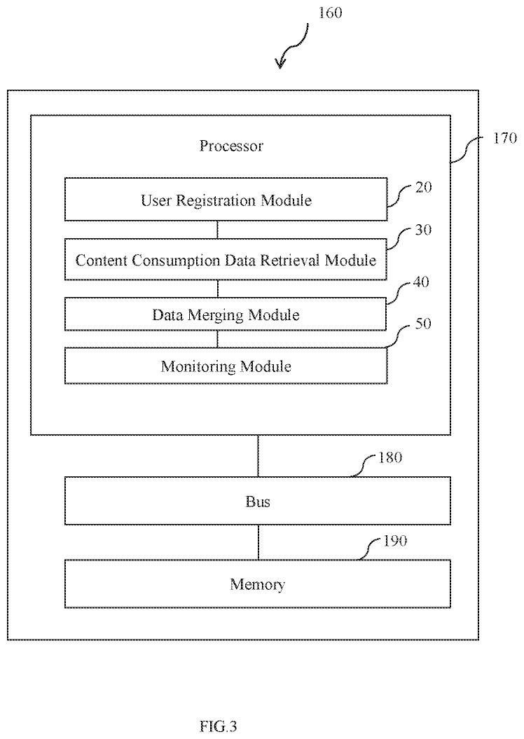

FIG. 3 block diagram of a computer or a server in accordance with an embodiment of the present disclosure. The system 160 includes a processor(s) 190, and a memory 190 coupled to the processor(s) 170.

The processor(s) 170, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s).

The memory 190 includes a plurality of modules stored in the form of executable program which instructs the processor to perform designated steps. The memory 190 has following modules: a user registration module 20, a content consumption data retrieval module 30, a user score generation module 40, and a reward generating module 50. The user registration module 20 is configured to register the plurality of users upon receiving a plurality of user details. The content consumption data retrieval module 30 operatively coupled to the user registration module 20. The content consumption data retrieval module 30 is configured to retrieve consumption data of one or more multimedia contents viewed by the plurality of users via a user device. Each of the one or more multimedia contents includes a loyalty value. The user score generation module 40 coupled to the content consumption data retrieval module 30, and configured to generate a user score based on at least one of the one or more multimedia contents viewed by the plurality of users and the corresponding loyalty value of the one or more multimedia contents. The loyalty value is based on the consumption data of the one or more multimedia contents. The reward generating module 50 operatively coupled to the user score generation module 40, and configured to generate a plurality of rewards based on a generated user score.

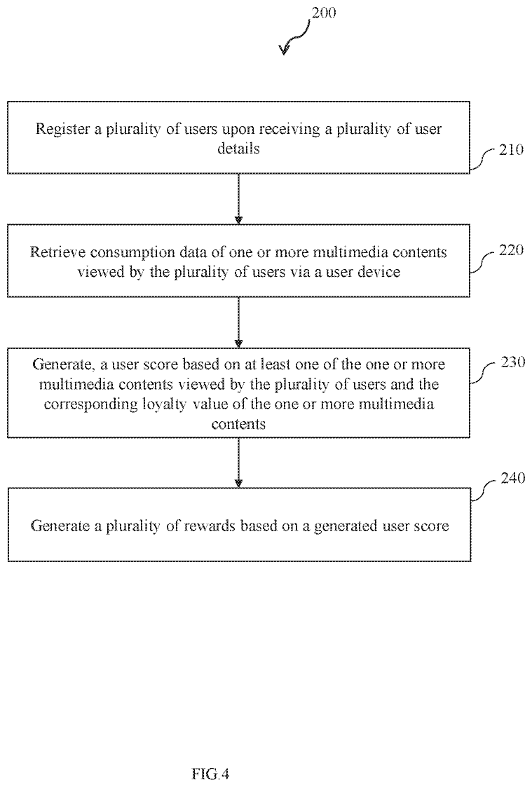

FIG. 4 is a flow diagram representing steps involved in a method 200 for generating rewards to a plurality of users based on content consumption in accordance with an embodiment of the present disclosure.

The method 200 includes registering the plurality of users upon receiving a plurality of user details in step 210. In one embodiment, registering the plurality of users includes registering the plurality of users upon receiving the plurality of user details by a user registration module. In one embodiment, the plurality of user details may include, a name of the plurality of users, an age of the plurality of users, an address of the plurality of users, an Electronic Mail (E-Mail) of the plurality of users, a phone number of the plurality of users, a nationality of the plurality of users, and the like. In one embodiment, the plurality of users may be a person who is a customer of over the top (OTT) media service.

The method 200 also includes retrieving consumption data of one or more multimedia contents viewed by the plurality of users via a user device in step 220. In one embodiment retrieving the consumption data of the one or more multimedia contents includes retrieving the consumption data of the one or more multimedia contents viewed by the plurality of users via a user device by a content consumption data retrieval module. In one embodiment, the content consumption data of the one or more multimedia contents comprises at least one of a type of the one or more multimedia contents, a time at which the one or more multimedia contents is viewed, cumulative watch-time of the one or more multimedia contents by the user device. In one embodiment, the user device may be a computing device such as a hand-held device or a portable device. In such embodiment, the computing device may include, but not limited to, a laptop, a desktop, a notebook, a tablet, a smartphone and the like.

In one embodiment, the loyalty value may be a value associated with the one or more multimedia content. In such embodiment, the loyalty value may vary based on content consumption data of the one or more multimedia contents. In one embodiment, the one or more multimedia contents may include, but not limited to, a free content which is seen at the appointed time frame, a free content which is seen after the time frame, a premium content, a pay per view content, a plurality of contents with different price, a plurality of contents with different importance and the like.

The method 200 also includes generating a user score based on at least one of the one or more multimedia contents viewed by the plurality of users and the corresponding loyalty value of the one or more multimedia contents in step 230. In one embodiment, generating the user score includes generating the user score based on the at least one of the one or more multimedia contents viewed by the plurality of users and the corresponding loyalty value of the one or more multimedia contents by a user score generation module. In one embodiment, the score may correspond to a numeric score generated to the corresponding plurality of users based on at least one of the one or more multimedia contents viewed by the plurality of users and the corresponding loyalty value of the one or more multimedia contents.

The method 200 also includes generating a plurality of rewards based on a generated user score in step 240. In one embodiment, generating the plurality of rewards includes generating the plurality of rewards based on the generated user score by a reward generating module. In one embodiment, the user can apply the plurality of rewards against the one or more multimedia contents. In one embodiment, the plurality of rewards may include, but not limited to, at least one of one or more deals, discounts, coupons, freebies, and subscriptions. In one exemplary embodiment, the plurality of rewards may be generated by an authorised person who may be managing telecast of the corresponding one or more multimedia contents.

In one embodiment, the method 200 further includes creating a user profile with the plurality of user details. In one embodiment, creating the user profile includes creating the user profile with the plurality of user details by a profile creation module. In one embodiment, the plurality of users may access a platform with social media login credentials. In one embodiment, the profile of the plurality of the users may include the plurality of user details.

In one embodiment, the method 200 further includes generating a permission to the authorised person to access the platform upon being accessed by the corresponding plurality of users. In one embodiment, generating the permission to the authorised person includes generating the permission to the authorised person to access the platform upon being accessed by the corresponding plurality of users by a permission providing module. In one embodiment, the plurality of permissions may include, but not limited to, permission to access location, permission to access user language, permission to track watch history, permission to send notification, permission to sync with calendar, and the like.

In one embodiment, the method 200 further includes determining a plurality of favourite items of the plurality of the user using a psychographic analysis technique based on the one or more contents accessed or watched by the plurality of user. In one embodiment, determining the plurality of favourite items includes determining the plurality of favourite items of the plurality of the user using the psychographic analysis technique based on the one or more contents accessed or watched by the plurality of user by a user favourites determining module. In one embodiment, the plurality of favourite items includes at least one of a favourite TV (Television) show, a favourite actor, a favourite actress, a favourite movie, and a favourite celebrity. In one embodiment, the user favourites determining module may determine the plurality of favourite items of the plurality of the user from history stored in a cache memory when the user is not logged in. In another embodiment, the plurality of favourite items of the plurality of the user may be determined from the user profile when the plurality of the users is logged in. In yet another embodiment, the plurality of favourite items of the plurality of the user may be determined via a plurality of questions/answers task which may be generated to the corresponding plurality of users and may have to be answered by the corresponding plurality of users. In one embodiment, the plurality of users may provide one or more answers to each of the plurality of questions.

In one embodiment, the method 200 further includes providing score to each of the plurality users based on the plurality of favourites. In one embodiment, providing the score includes providing the score to each of the plurality users based on the plurality of favourites by a score providing module. In one embodiment, the score may be based on a number of one or more matched answers provided by the plurality of users.

In one embodiment, the method 200 further includes matching the rank of each the plurality of users with one another to generate a list of a plurality of matched users. In one embodiment, matching the rank of the plurality of users includes matching the rank of the plurality of users with the one another to generate the list of the plurality of matched users by a rank matching module.

In one embodiment, the method 200 further includes creating a chat list based on the rank. In one embodiment, creating the chat list includes creating the chat list based on a provided rank by a chat list creation module. The chat list allows the plurality of matched users to interact via chat/talk with each other on the platform. In one embodiment, the chat list will be the same until the plurality of users do not change the plurality of favourites.

In one embodiment, the method 200 further includes providing a plurality of feeds. In one embodiment, providing the plurality of feeds includes providing the plurality of feeds by a feed providing module. In one embodiment, a plurality of items may include, but not limited to a plurality of videos, a plurality of gossips, a plurality of Tid-bits, a plurality of Trivia, a plurality of Quiz.

In one embodiment, the method 200 further includes displaying and storing a list of movies, a list of new movies, a list of most liked movies, and a list of most liked shows, a list of most liked movies with the corresponding celebrities, a list of most liked celebrities, a list of trending shows, a list of trending movies within a directory on the platform. In one embodiment, displaying and storing the list of movies, the list of new movies, the list of most liked movies, the list of most liked shows, the list of most liked movies with the corresponding celebrities, the list of most liked celebrities, the list of trending shows, the list of trending movies includes displaying the list of movies, the list of new movies, the list of most liked movies, the list of most liked shows, the list of most liked movies with the corresponding celebrities, the list of most liked celebrities, the list of trending shows, the list of trending movies within the directory on the platform by a directory module.

In one embodiment, the method 200 further includes displaying at least one of one or more screensavers, the one or more wallpapers, the one or more tunes corresponding to the at least one of the one or more movies, the one or more shows, and the one or more celebrities on a display of the user device. In one embodiment, displaying the at least one of the one or more screensavers, the one or more wallpapers, the one or more tunes, the one or more costumes, the one or more properties seen in the content includes displaying the at least one of the screensaver, the wallpaper, the tune, the one or more costumes, and the one or more properties seen in the content corresponding to the at least one of the one or more movies, the one or more shows, and the one or more celebrities on the display of the user device by a home page module. In one embodiment, the at least one of the one or more screensavers, the one or more wallpapers, the one or more tunes, the one or more costumes, and the one or more properties seen in the content may be downloaded by the plurality of users.

In one embodiment, the method 200 further include enabling the plurality of users to perform at least one of a plurality of retail business activities and a plurality of retail purchases on at least one of the one or more screensavers, the one or more wallpapers, the one or more tunes, the one or more costumes, and the one or more properties seen in the content upon viewing the same on the display of the user device. In one embodiment, enabling the plurality of users to perform the at least one of the plurality of retail business activities and the plurality of retail purchases includes enabling the plurality of users to perform the at least one of the plurality of retail business activities and the plurality of retail purchases on the at least one of the one or more screensavers, the one or more wallpapers, the one or more tunes, the one or more costumes, and the one or more properties seen in the content upon viewing the same on the display of the user device by a retail business activity module. In one embodiment, the viewing options may include one of a two-dimensional view and a three-dimensional view. In such embodiment, the at least one of the plurality of retail business activities and the plurality of purchases against the loyalty points earned as part of loyalty program.

In one embodiment, enabling the plurality of users to perform the at least one of the plurality of retail business activities and the plurality of purchases of a plurality of properties of the at least one of the one or more movies, the one or more shows, and the one or more celebrities from the set. In one embodiment, enabling the plurality of users to perform the at least one of the plurality of retail business activities and the plurality of purchases includes enabling the plurality of users to perform the at least one of the plurality of retail business activities and the plurality of purchases of the plurality of properties of the at least one of the one or more movies, the one or more shows, and the one or more celebrities from the set by the retail business activity module. In such embodiment, the at least one of the plurality of retail business activities and the plurality of purchases against the loyalty points earned as part of loyalty program.

In one embodiment, the plurality of properties may include, but not limited to one or more products which may be associated with the corresponding one or more multimedia content.

In one embodiment, the method 200 further includes generating a celebrity score based a set of parameters of the one or more multimedia contents. In one embodiment, generating the celebrity score includes generating a celebrity score based on the set of parameters of the one or more multimedia contents. In one embodiment, the set of parameters may include, but not limited to, at least one of number of downloads of the one or more multimedia contents, number of completed episodes of the one or more multimedia contents, and number of repeated views of the episodes of the one or more multimedia contents and the like. The celebrity score will be generated based on the set of parameters for the at least one of the one or more movies, the one or more shows, and the one or more celebrities which will decide popularity rating of the at least one of the one or more movies, the one or more shows, and the one or more celebrities.

In one embodiment, the method 200 further includes allowing the plurality of users to make a playlist, and manage the playlist of the at least one of movies/shows/celebrity. In one embodiment, allowing the plurality of users to make the playlist includes allowing the plurality of users to make the playlist of the at least one of movies/shows/celebrity by a playlist preparation module.

In one embodiment, the method 200 further includes allowing the plurality of users to manage the playlist of the at least one of movies/shows/celebrity. In one embodiment, allowing the plurality of users to manage the playlist includes allowing the plurality of users to manage the playlist of the at least one of movies/shows/celebrity by the playlist preparation module.

In one embodiment, the method 200 further includes allowing the user to add the at least one of movies/shows as favourites. in one embodiment, allow the plurality of users includes allowing the plurality of users to add the at least one of movies/shows as favourites by a favourite module.

In one embodiment, the method 200 further includes allowing the plurality of users to download to download the at least one of the one or more movies, the one or more shows, and one or more songs by paying monthly and annual subscription. In one embodiment, allowing the plurality of users includes allowing the plurality of users to download the at least one of the one or more movies, the one or more shows, and one or more songs by paying monthly and annual subscription by a download module.

In one embodiment, the method 200 further includes allowing the plurality of users to share the user score/the celebrity score with friends in social media. In one embodiment, allowing the plurality of users includes allowing the plurality of users includes to share the user score/the celebrity score with friends on a social media platform by a score share module.

In one embodiment, the method 200 further includes allowing the plurality of users to create a watch feed with next episodes of the at least one of movies/shows. In one embodiment, allowing the plurality of users includes allowing the plurality of users to create the watch feed with next episodes of the at least one of movies/shows by a watch feed creating module.

In one embodiment, the method 200 further includes allowing the plurality of users to share the broadcast with friends of the plurality of the users. In one embodiment, allowing the plurality of users to share the broadcast includes allowing the plurality of users to share the broadcast with one or more friends associated with the plurality of the users.

In one embodiment, the method 200 further includes allowing each of the plurality of users to follow the one another to listen to the broadcast done by the each of the plurality of users. In one embodiment, allowing the each of the plurality of users to follow includes allowing each of the plurality of users to follow the one another to listen to the broadcast done by each of the plurality of users by the broadcast sharing module.

In one embodiment, the method 200 further includes the plurality of users to select at least one of a language, a theme, and one or more font styles. In one embodiment, allowing the plurality of users to select includes allowing the plurality of users to select the at least one of a language, a theme, and one or more font styles. In one embodiment, the language selected from the list of regional languages.

In one embodiment, the method 200 further includes providing the platform details to the plurality of users. in one embodiment, providing the platform details includes providing the platform details to the plurality of users by s settings module. In one embodiment, the platform details may include, but not limited to, version of the platform, and a logo of the platform.

In one embodiment, the method 200 further includes allowing the plurality of user to provide a rating to the platform. In one embodiment, allowing the plurality of user to provide the rating includes allowing the plurality of user to provide rating to the platform by the settings module.

Various embodiments of the present disclosure enable the system to provide personalized content to the plurality of users via the computing device. In addition to that, the present disclosure allows the plurality of users to earn money/rewards/credit points which will increase the interest of the plurality of users to invest more time on such entertaining programs.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system 10 to generate rewards to a plurality of users based on content consumption, comprising:
a user registration module 20 configured to register the plurality of users upon receiving a plurality of user details;
a content consumption data retrieval module 30 operatively coupled to the user registration module 20, and configured to retrieve consumption data of one or more multimedia contents viewed by the plurality of users via a user device, wherein each of the one or more multimedia contents comprises a loyalty value;
a user score generation module 40 coupled to the content consumption data retrieval module 30, and configured to generate a user score based on at least one of the one or more multimedia contents viewed by the plurality of users and the corresponding loyalty value of the one or more multimedia contents, wherein the loyalty value is based the consumption data of the one or more multimedia contents; and
a reward generating module 50 operatively coupled to the user score generation module 40, and configured to generate a plurality of rewards based on a generated user score.

2. The system 10 as claimed in claim 1, wherein the content consumption data of the one or more multimedia contents comprises at least one of a type of the one or more multimedia contents, a time at which the one or more multimedia contents is viewed, cumulative watch-time of the one or more multimedia contents.

3. The system as claimed in claim 1, wherein the plurality of rewards comprises at least one of one or more deals, discounts, coupons, freebies, and subscriptions against the one or more multimedia contents.

4. The system as claimed in claim 1, further comprising a user favourites determining module operatively coupled to the user registration module 20, and configured to determine a plurality of favourite items of the plurality of the users using a psychographic analysis technique, wherein the plurality of favourite items comprises at least one of a favourite TV (Television) show, a favourite actor, a favourite actress, a favourite movie, and a favourite celebrity.

5. The system 10 as claimed in claim 1, further comprising a celebrity score generation module coupled to the content consumption data retrieval module 30, and configured to generate a celebrity score based a set of parameters of the one or more multimedia contents, wherein the set of parameters comprises at least one of number of downloads of the one or more multimedia contents, number of completed episodes of the one or more multimedia contents, and number of repeated views of the episodes of the one or more multimedia contents.

6. A method 200 for generating rewards to a plurality of users based on content consumption, comprising:
registering, by a user registration module, the plurality of users upon receiving a plurality of user details;
retrieving, by a content consumption data retrieval module, consumption data of one or more multimedia contents viewed by the plurality of users via a user device;
generating, a user score generation module, a user score based on at least one of the one or more multimedia contents viewed by the plurality of users and the corresponding loyalty value of the one or more multimedia contents and
generating, a reward generating module, a plurality of rewards based on a generated user score.

7. The method 200 as claimed in claim 6, wherein generating the user score based the at least one of the one or more multimedia contents viewed by the plurality of users and the corresponding loyalty value of the one or more multimedia contents enabled by consumption data of the one or more multimedia contents comprises generating the user score based the at least one of the one or more multimedia contents viewed by the plurality of users and the corresponding loyalty value of the one or more multimedia contents enabled by at least one of a type of the one or more multimedia contents, a time at which the one or more multimedia contents is viewed, cumulative watch-time of the one or more multimedia contents.

8. The method 200 as claimed in claim 6, Wherein generating the plurality of rewards based on the generated user score comprises generating at least one of a one or more deals, discounts, coupons, freebies, and subscriptions based on the generated user score.

9. The method 200 as claimed in claim 6, further comprising generating, a celebrity score generation module, a celebrity score based a set of parameters of the one or more multimedia contents, wherein the set of parameters of the one or more multimedia contents comprises generating the celebrity score based on at least one of number of downloads of the one or more multimedia contents, number of completed episodes of the one or more multimedia contents, and number of repeated views of the episodes of the one or more multimedia contents.

10. The method 200 as claimed in claim 6, further comprising determining a plurality of favourite items of the plurality of the users comprises at least one of a favourite TV (Television) show, a favourite actor, a favourite actress, a favourite movie, and a favourite celebrity.
